(19) United States
(12) Patent Application Publication
(10) Pub. No.: US 2009/0322773 A1
(43) Pub. Date: Dec. 31, 2009

(54) DIGITAL PHOTO FRAME

(75) Inventor: MIN-DA DING, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/334,722

(22) Filed: Dec. 15, 2008

(30) Foreign Application Priority Data
Jun. 27, 2008 (CN) 200810302396.X

(51) Int. Cl. G09G 5/00

(52) U.S. Cl. 345/581

(57) ABSTRACT

A digital photo frame includes a display unit, a storage unit, and an annotation input unit. A display unit includes an image display unit and an annotation display unit. The storage unit stores an image and an annotation associated with the image. An annotation input unit inputs the annotation associated with the image. The display unit displays the image and the annotation associated with the image simultaneously.

### BACKGROUND

1. Technical Field

The present disclosure relates to a digital photo displaying device and, especially, to a digital photo frame.

2. Description of Related Art

With the development of digital cameras and digital image rendering for personal computers, pictures may now be stored in a memory storage device such as a hard drive of a computer. Such pictures require a video card for viewing. Although storage of the digital images on a computer is space effective and efficient, it may not be suitable for every day use since the image must be retrieved from memory for display on the computer display.

In some instances, individuals desire a more convenient method of viewing images. Therefore, a need exists for a digital display frame capable of displaying a plurality of digital images easily and conveniently. A further need exists for a digital picture frame that simultaneously displays annotations associated with the displayed digital images.

### BRIEF DESCRIPTION OF THE DRAWINGS

FIG. 1 is a view of an embodiment of a digital photo frame, the digital photo frame including a display;

FIG. 2 is a component block view of FIG. 1;

FIG. 3 is a flowchart of a method for adding an annotation for an image of the digital photo frame; and

FIG. 4 is a flowchart of a method for displaying an image of the digital photo frame.

### DETAILED DESCRIPTION OF THE EMBODIMENTS

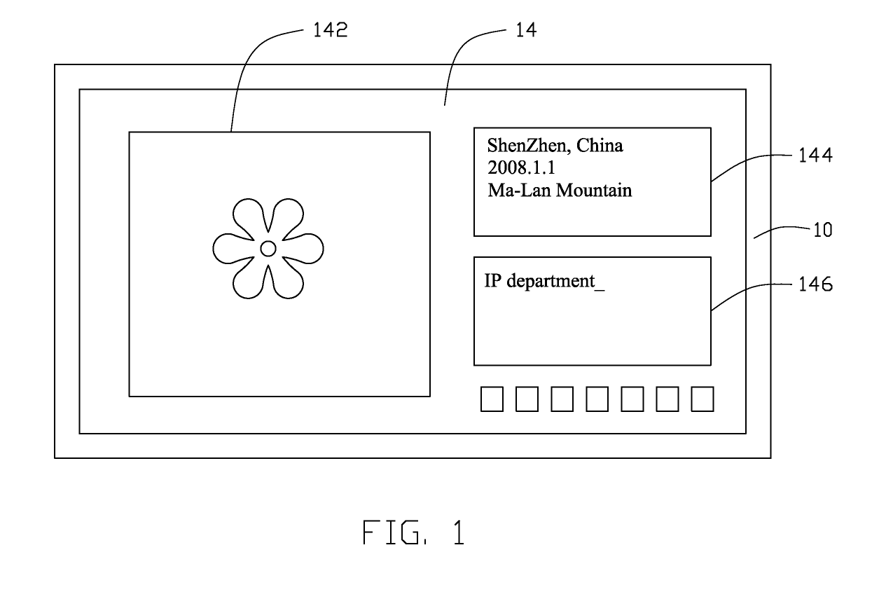

Referring to FIG. 1, an embodiment of a digital photo frame (DPF) 10 includes a screen or a display 14. The display 14 may be a liquid crystal display (LCD), a passive display, an active display or any other known display. A graphical user interface (GUI) of the DPF, includes an image display window 142, an annotation display window 144, and an annotation input window 146, all displayed in close proximity to each other on the display 14. The annotation display window 144 displays an annotation associated with a currently viewed image.

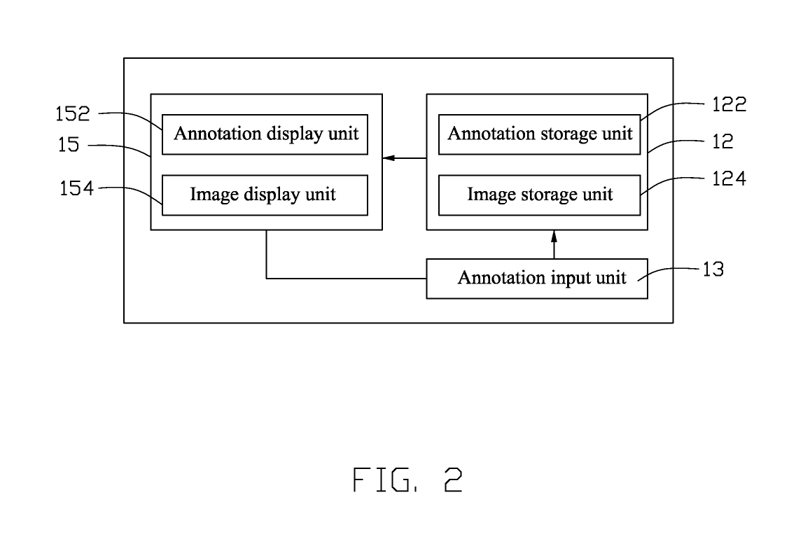

Referring also to FIG. 2, the DPF further includes a display unit 15, a storage unit 12, and an annotation input unit 13. The display unit 15 includes an image display unit 154 communicating with the image display window 142, and an annotation display unit 152 communicating with the annotation display window 144. The storage unit 12 includes an image storage unit 124 to store a plurality of images, and an annotation storage unit 122 to store the annotations associated with the images. The annotation input unit 13 communicates with the annotation input window 146 and receives input by users for annotating the images.

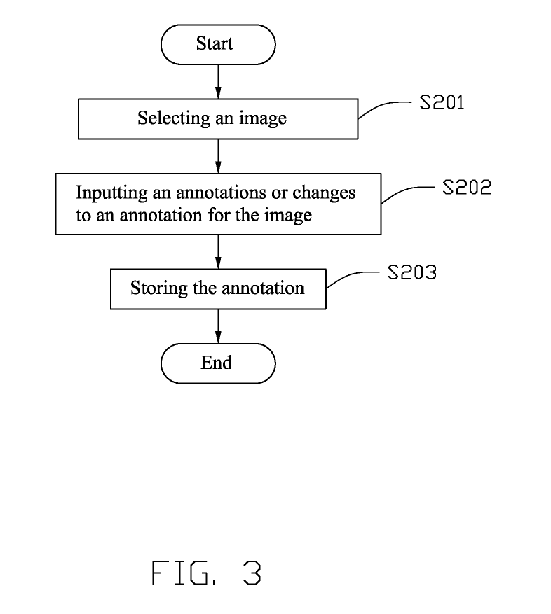

Referring to FIG. 3, a flowchart of a method of annotating an image of the DPF is shown. Depending on the embodiment, certain of the steps described below may be removed, others may be added, and the sequence of steps may be altered. The method includes the following steps:
S201: selecting an image from an image storage unit 122 to be displayed in the image display window 142;
S202: inputting an annotation or changes to an annotation for the image;
S203: storing the annotation in the annotation storage unit 121.

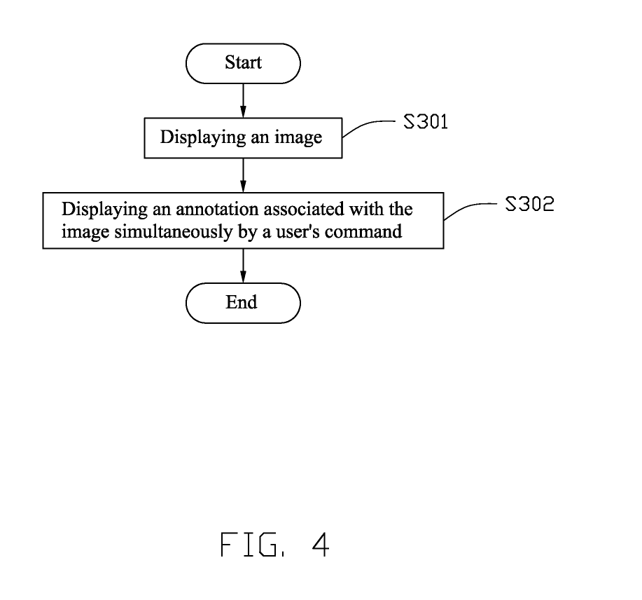

Referring to FIG. 4, a method of displaying an image of the present embodiment is shown. Depending on the embodiment, certain of the steps described below may be removed, others may be added, and the sequence of steps may be altered. The method includes the following steps:
S301: displaying an image in the image display window 142 automatically or by a user's command;
S302: displaying an annotation associated with the image in the annotation display window 144 simultaneously or by a user's command.

It is to be understood, however, that even though numerous characteristics and advantages of the present embodiments have been set forth in the foregoing description, together with details of the apparatus and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A digital photo frame (DPF), comprising:
a display unit comprising an image display unit and an annotation display unit;
a storage unit configured to store an image and an annotation associated with the image, and
an annotation input unit configured to input the annotation associated with the image, wherein the display unit displays the image and the annotation associated with the image simultaneously.

2. The DPF of claim 1, wherein a display communicates with the display unit to display information to a user.

3. The DPF of claim 2, wherein an image display window communicating with the image display unit to display the image, and an annotation display window communicating with the annotation display unit is positioned adjacent to the image display window to present the annotation.

4. A method of displaying an image in a DPF, the method comprising:
displaying the image in an image display window automatically or by a user's command; and
displaying an annotation associated with the image in an annotation display window on demand.

5. The method of claim 4, wherein the annotation associated with the image is displayed with the image automatically.

6. The method of claim 4, wherein the annotation associated with the image is displayed with the image by a user's command.

7. The method of displaying an image in a DPF of claim 4, wherein the annotation display window is adjacent to the image display window.

8. A method of editing an attribute of an image in a DPF, the method comprising:
selecting the image from an image storage unit;
inputting an annotation, to be associated with the image, using an annotation input window; and
storing the annotation in an annotation storage unit.

9. The method of claim 8, wherein the annotation input window is displayed in a display of the DPF.
